(19) United States
(12) Patent Application Publication
(10) Pub. No.: US 2009/0181702 A1
(43) Pub. Date: Jul. 16, 2009

(54) MULTI-MODE COMMUNICATION

(75) Inventors: Sandra Irene Vargas, Sammamish, WA (US); Keith Rowe, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/013,924

(22) Filed: Jan. 14, 2008

(51) Int. Cl. H04Q 7/20

(52) U.S. Cl. 455/466

(57) ABSTRACT

A method for operating a communications system is provided. The method includes receiving a text communication from a first user destined for a second user. One of a number of user communication points on which to connect the text communication to the second user is selected, and a suitable communication type capable of displaying the text on the selected communication point is determined. The text communication is then forwarded the second user using the communication type.

### BACKGROUND

The capabilities and features of mobile communication devices such as cellular phones have increased dramatically. Devices are no longer limited to merely making calls, but include geo-positioning transceivers, high speed data channels and advanced application programming interfaces. Applications that provide email and internet access, calendar and scheduling features, music player capabilities, and synchronization to other devices are just a few of the available features on many mobile devices.

The manner in which people use mobile devices has changed in accordance with the capabilities provided. Text messaging, email, and instant messaging are increasingly popular non-verbal uses of the devices. Communication devices typically include an address book which contains a number of addresses corresponding to the different ways one can communicate with one's contacts. For example, a contact's address book entry may include an email address, a land-based telephone number, an instant message address, and a wireless telephone number which also serves as Short Message Service (SMS) text address. Advanced devices allow users to store groups of contacts and to address communications to the group as a whole.

Before a device user can contact someone in their address book, the user generally has to select a communications method. For a verbal telephone call, this is relatively straightforward as the person to whom the user wishes to communicate generally has one or several numbers, one of which the user knows is the preferred number to contact. To communicate via text messaging or non-verbal communication, the user on a communication device may not know whether the person to whom they wish to communicate is “present” at any given time. For example, a user with an email address, phone number, and an instant message address may be away from the device which allows that user to utilize instant messaging.

Presence information is a status indicator that conveys the ability of a potential communication partner to communicate via a particular medium. One commonly used type of presence is to display an indicator icon in instant messaging clients.

### SUMMARY

A technology to seamlessly connect users is provided. An initiating user utilizes a unified communication interface to select a user or a group of users. The system automatically selects both a connection point and communication format for the person to whom the user wishes to communicate. This selection is made based on presence information, delivery options and user preferences.

The technology includes a method of operating a communication system by receiving a text communication from a first user destined for a second user. One of a number of user communication points at which to connect the text communication to the second user is selected, and a suitable communication type capable of displaying the text on the selected communication point is determined. The text communication is then forwarded to the second user using the communication type.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a communications environment suitable for implementing the present technology.

FIG. 2 is a method implemented by the present technology to allow users to communicate via the best available mode of communication.

FIGS. 3 and 4 are examples of a user interface for user contacting another user in accordance with the present technology.

FIG. 5 is a method illustrating the manner in which the technology establishes connection with a particular user.

FIG. 6 is a flow chart illustrating a method by which the technology determines the communication data path for a connected user.

FIG. 7 is a flow chart illustrating user communication in accordance with the technology amongst a group of users.

FIGS. 8 and 9 are examples of a User-to-Group user interface screen provided in accordance with the technology presented herein.

FIG. 10 is an example of a wireless communication device suitable for use in accordance with the technology presented herein.

FIG. 11 is a processing device suitable for use in implementing many of the processing devices discussed herein.

### DETAILED DESCRIPTION

The technology disclosed herein allows a user to communicate with another person in the most timely manner. An initiating user utilizes a unified communication interface to select a user or a group of users. The system automatically selects both a connection point and communication format for the person to whom the user wishes to communicate. This selection is made based on presence information, delivery options and user preferences. In addition, the technology allows for transitioning between text and voice communications during the communication session. The technology enables users to think about who they wish to communicate with rather than the particular technology through which they need to communicate.

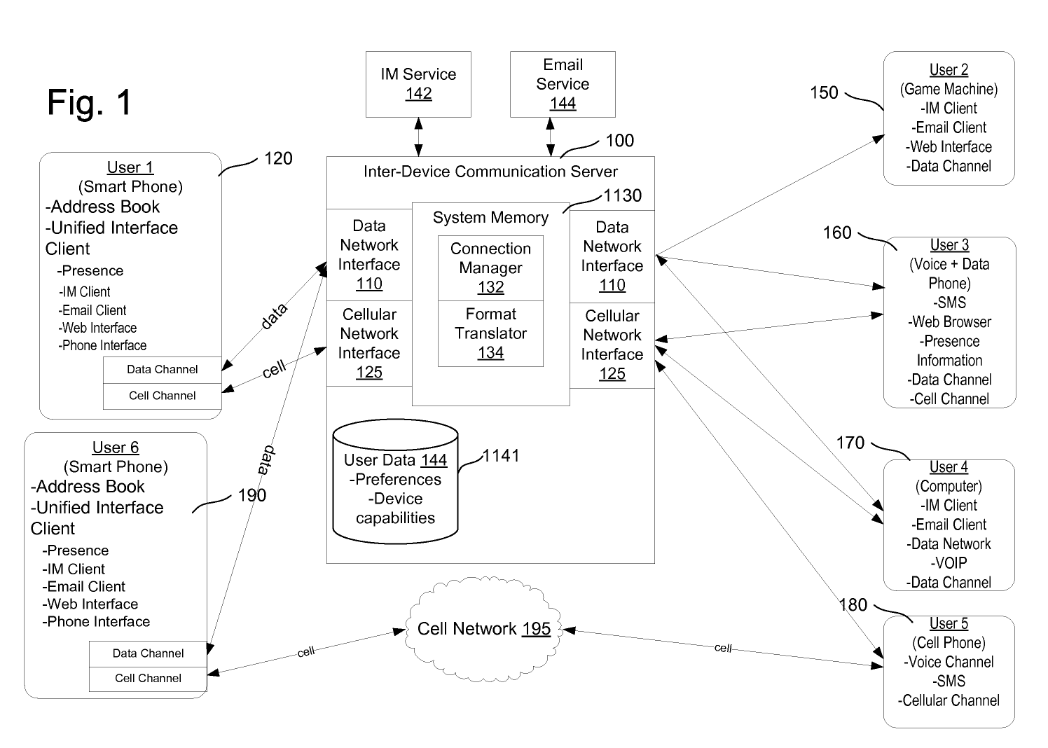

FIG. 1 illustrates a communications environment suitable for use in implementing the present technology. FIG. 1 illustrates a number of users 150, 160, 170, 180, 190, each operating a user device having different communications characteristics and capabilities. Each of the users in FIG. 1 communicates with other users through or in conjunction with an interdevice communications server 100.

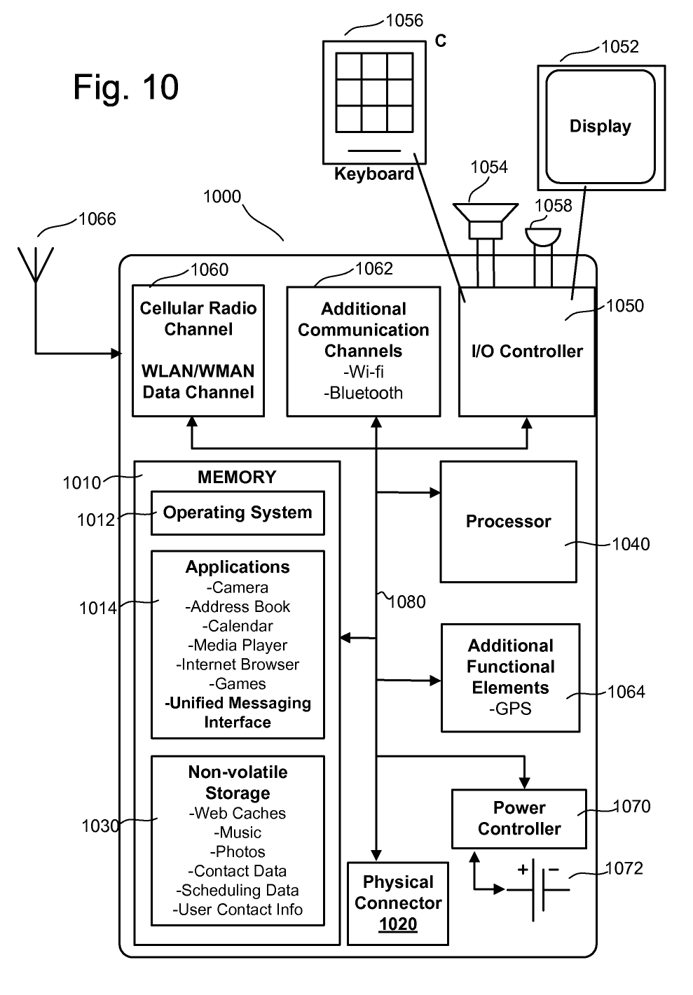

Users may be operating and therefore “present” on different types of devices. It should be understood that any of the users operating in accordance with the present technology may be utilizing any of the particular devices discussed herein. For purposes of illustration only, Users 1 and 6 are operating so-called “smart phone” 120, 190. Typically, smart phones include a voice or cellular channel, a data channel, and a processing device which may be programmed to perform a number of functions. The cellular channel and data channel operate independently and simultaneously. An example of one such smart phone is illustrated in FIG. 10. The processing device includes a number of applications including, among other applications, an address book, and a unified communication client. A unified communication client may include, for example, an instant messaging client, an email client, a web interface, a phone interface and presence indicator. The unified communication client likewise may include an interface (a unified interface) allowing access to each of the communication methods provided by the client.

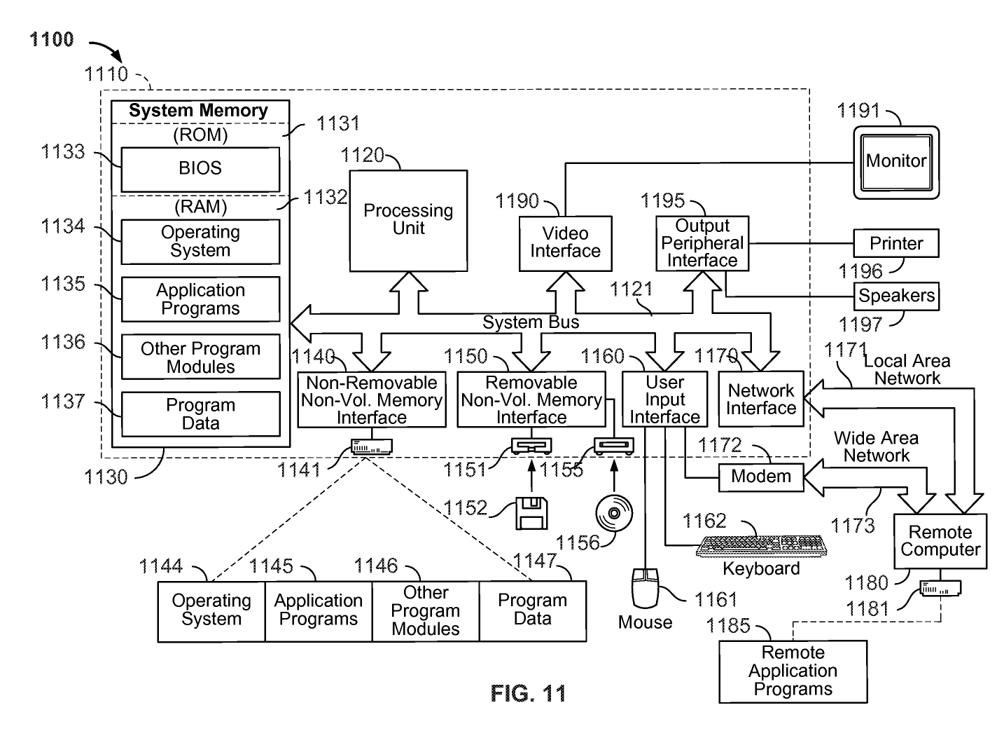

User 2, for example, is using a gaming machine 150 such as an Xbox 360®. Game machine 150 may include an instant messaging client providing preference information, an email client, and a web interface. The device 150 may further include a data channel which may be used to access the interdevice communications server 100. User 3 may be utilizing a voice and data capable cellular phone 160. Such a phone might include applications such as a web browser and SMS texting capability, but may not include instant messaging client providing presence information. Another example is User 4 utilizing a processing device 170, an example of which is illustrated shown in FIG. 11. The processing device 170 can utilize any number of different communications mechanisms, including a data network for communicating with the interdevice communications server 100, and may have applications such as an email client, a voice over IP client, and an instant messaging client (or unified commuinication client) providing presence information. User 5 may be utilizing a non data-cellular capable phone 180 which only includes a voice or cellular channel and capability of providing SMS messages.

The interdevice communications server 100 includes one or more data network interfaces 110, one or more cellular network interfaces 125, a connection manager and format translator provided in system memory, and user data 144 stored in nonvolatile storage 1141. The user data 144 may include user preferences and user device capabilities. For each user, these capabilities may include the type of devices that the user operates, and application capabilities of such devices. User preferences may also include the manner in which a user wishes to communicate with another user, as well as the manner in which the user wishes to be communicated with by another user. A connection manager 132 and format translator 134 comprise instructions resident in system memory 1130 to allow a processing device in the server 100 to perform the functions described herein. As discussed below, the connection manager 132 and format translator 134 allow a user such as User 1 to communicate with any Users 2 through 6 in a seamless manner, through the unified interface, and in a manner best available to each of the respective users and their respective devices.

Connections between devices and contact points may be managed by the server 100. The connection manager 132 may include, for example, an email server, an instant messaging server, or an interface directing connections between devices and external instant messaging 142 or email servers 146. As such, instant messaging clients providing presence information may connect though the connection manager 132 to an instant messaging service 142, or the service may be maintained by the connection manager 132. Likewise, emails forwarded from devices may be handled by the connection manager 132 directly or routed through the connection manager to an e-mail service 146. In addition, voice calls may be handled via the data network connections using Voice over IP (VOIP) applications, or voice connections may be routed via a cellular network 195, with additional information (such as presence information) being maintained by the connection server 100. In one example, voice communications between devices including a cellular channel can be connected via a traditional cellular network 195 while call information (including which users are connected, the state of the connection, and the state of each user's device) is maintained via a data connection to the server 100.

For example, in FIG. 1, User 6 may have a cellular voice call connected via a cellular network 195 to User 5. In such case, device 190 may still provide presence and call information to the server 100. This information may include the fact that User 6 is in communication with User 5, allowing the connection manager 132 to intelligently decide that User 6 should not be interrupted with an instant message until it is off the call or allowing User 6 to quickly switch to a text mode of communication with User 5.

Each device and each communications mechanism or application on the device represents a contact point for the user. Hence a user may have multiple contact points on a device. Each contact point is accessed using a different communications format or type. For example, while email and instant messaging clients transmit text between points, the communications format used by instant messaging is different than that used in email. The format translator routes text messages between the different types of formats as connections are specified by the connection manager.

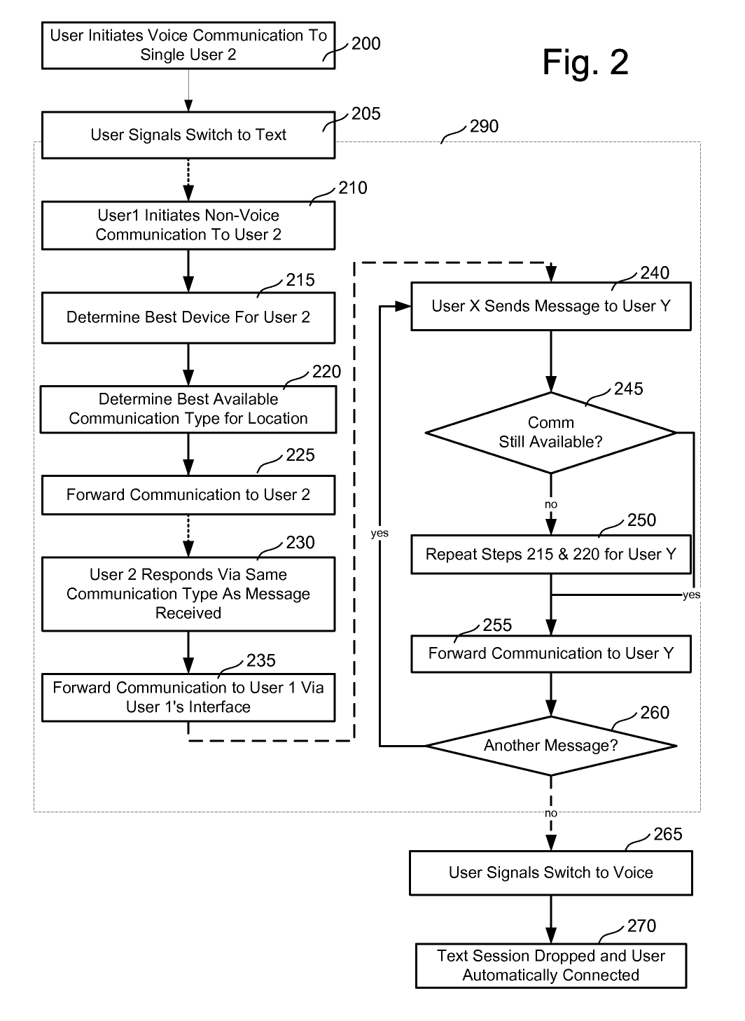

FIG. 2 illustrates a general method in accordance with the present technology allowing users to communicate with each other in real time in the most convenient manner relative to the device they are using. The method 290 is generally comprised of steps 210 through 260. The method may be initiated when a user who has previously initiated a voice communication to a second user at step 200 initiates a switch to text option in a communications interface at step 205 such as that provided on device 120.

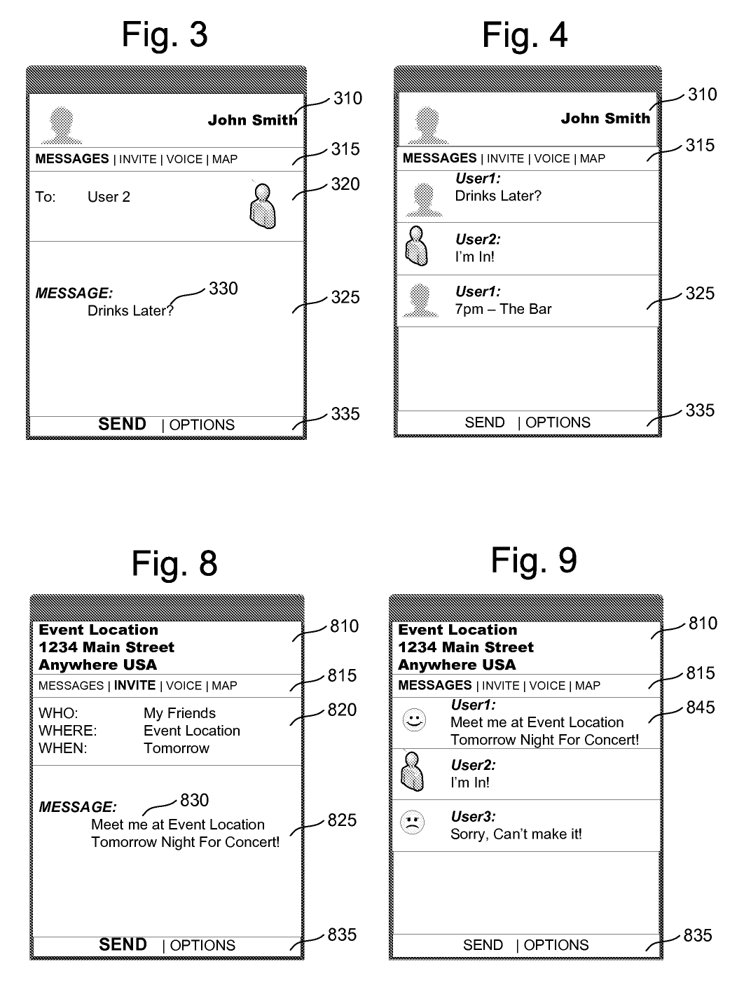

As noted above, because the interdevice communication manager is aware of presence and call state information, the communication manager can enable this switch during the voice call. In an alterative embodiment, the method begins when a first user, User 1, initiates a non-voice communication to a second user to User 2 at step 210 by selecting a text mode of communication. Non-voice communication may be initialized through the unified communication interface application resident on device 150. An example of a user interface for a unified communication interface is shown in FIG. 3. To User 1, initiation at step 210 may be as simple as selecting User 2's name from a contact list or address book. The choice of the connection type and destination is made by the connection manager performing aspects of the method shown in FIG. 1.

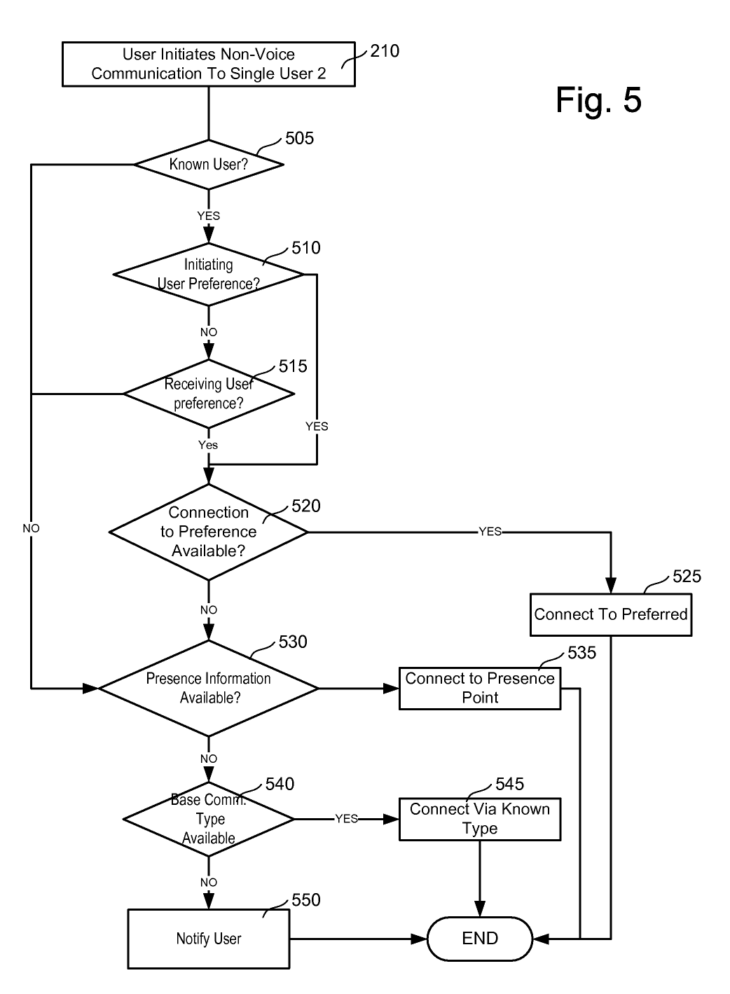

Once the user initiates a non-voice communication at step 210, the technology determines the best destination to communicate with User 2 at step 215. In the example shown in FIG. 1, User 2 is on a game machine. However, it is also possible that a user may be on multiple devices at the same time. For example, User 2 may also possess a data enabled cellular phone such as that shown at 120 or 160 of FIG. 1 and may simultaneously be playing the game machine with the cellular phone enabled. Likewise, a user may be operating a computer 170 and have a data enabled cellular phone 180, both of which could be presence points for contacting a particular user. At step 215, the technology determines which device to contact User 2 on, based on a combination of User preferences, presence information, device capabilities and connection history. A process for making this determination is illustrated in FIG. 5.

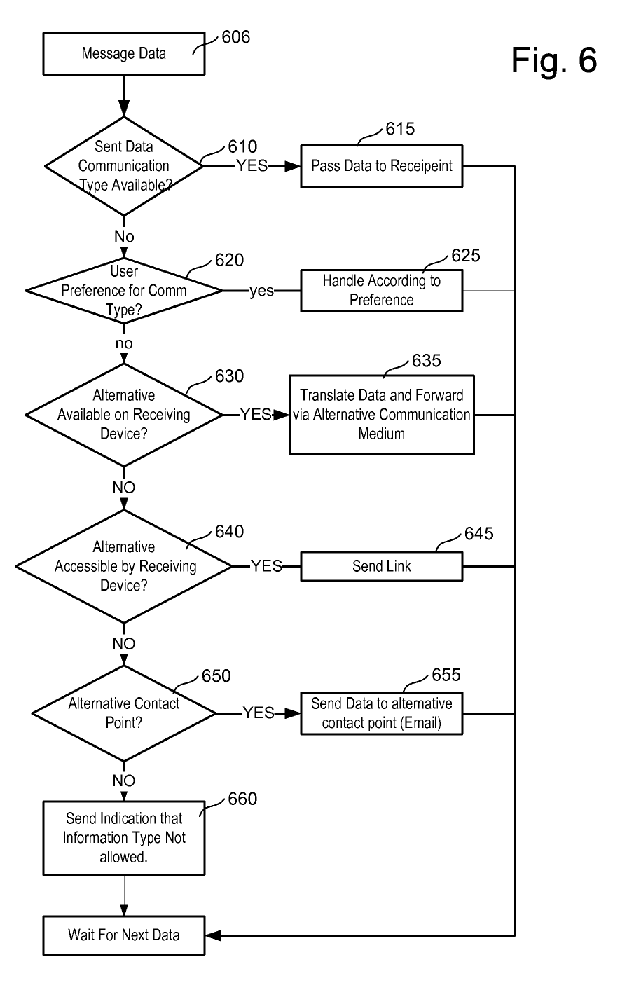

Once the technology determines the best destination to communicate with the user at step 215, the technology determines the best available communication type for that particular location at step 220. As noted with respect to FIG. 1, each location will have different capabilities with respect to the type of information and responsiveness that the user has available to him at such locations. In determining the best communication type for the location, as discussed below with respect to FIG. 6, user preferences and device capabilities are taken into account.

Note that steps 215 and 220 may be reversed or combined. That is, in determining the best destination to route non-verbal communications between users, the availability of a particular feature or communication type may be taken into account. FIG. 6 illustrates steps 220/225 in additional detail.

At step 225, the communication initiated by User 1 is forwarded to User 2. At step 220, if the technology has determined that the best format for communicating with User 2 is to send User 2 an instant message, then the user will receive an instant message through the instant messaging client on the destination device. If, for example, the user is trying to communicate with User 5, and only an SMS text interface is available, then User 5 would receive the message generated by User 1 via an SMS message. To both users, the communication type of the other is transparent. For example, at step 225, the message may be forwarded to User 2 via an SMS message. User 2 may reply to the SMS message at step 230 by generating a second SMS message. In accordance with the technology, at step 235, the communication is returned to User 1 via the same communication type utilized by User 1. Hence, the method of communication with User 2 is transparent to User 1. Likewise, to User 2, the mechanism User 1 is utilizing is transparent.

This transparency from the perspective of User 1 is illustrated in FIG. 3. FIG. 3 illustrates a unified communications interface which is available to User 1 on device 120. Interface includes a user identification panel 310, a menu bar 315, an address panel 320, a message panel 325 including a message 330 and a send menu bar 335. User 1, in this example John Smith, selects the addressee User 2 in the panel 320 and composes a message 330 in message panel 325 using the device's text entry interface. Clicking the send menu item on menu bar 335 forwards the message at step 210 in FIG. 2. With reference to FIG. 1, the message will be forwarded via the data network to the data network interface 110. Responses from User 2 will appear in the message window 325 as illustrated in FIG. 4. Responses from User 2 will be illustrated by a separate user icon and other means for identifying that the replies are coming from User 2. In this case, the message appears in a UI window in FIG. 4 as a message stream.

Returning to FIG. 2, the communication between the users can continue in this manner until the end of a communication session. After initial messages are exchanged at step 235, at some later point, as illustrated by the dash line between steps 235 and 240, users may continue sending messages back and forth. At step 240, User X can comprise either User 1 or User 2 and User Y can comprise either User 1 or User 2. At step 240, upon initiation of a subsequent message, at step 245, the technology determines whether or not the same communications destination and type is available for communicating with the user during the session. If the communication type is available, then at step 255, the communication is forwarded to User Y using the same communication type as the user received its last message in. If the communication type is not available, then steps 215, 220 are repeated for User Y to determine a new destination and new communication type for the user, before the message is forwarded to the user at step 255. The method repeats at step 260 for each message generated between respective users during a communication session.

As further illustrated in FIG. 2, the technology allows the user who has initiated a voice communication at step 200, to automatically switch to a text conversation at step 205. As illustrated in FIG. 3, the interface includes a voice selection item on menu bar 315 which allows a user, during a text session, to transfer the communication to a voice session. This is illustrated at step 265 in FIG. 2. At step 270, the text session will be dropped and the user will be automatically connected via the interdevice communications server to the appropriate channel on the other user's device. Likewise, during a voice communication, a user may select to convert to a text session. This is illustrated at steps 200 and 205.

FIG. 5 illustrates a method for establishing a connection between a first user and a second user which determines the best connection point to make a connection. The method of FIG. 5 may be performed by connection manager 132 operating on the interdevice communications server. FIG. 5 generally illustrates the method performed at step 215 in FIG. 2. After a user initiates a non-voice communication at step 210, the method first checks to determine whether the user to which the communication is designated is known at step 505. If the user is known, at step 505, the method will check to determine whether or not the initiating user, in this example User 1, has a preference for connecting to User 2 at step 510. For example, the initiating user may specify a preference that all communications first be attempted to be made to the destination user's internet messaging application. Preferences may be entered and stored using an address book application in a record associated with contact information for a user, through the unified interface application, or though any other manner of creating and storing a record. The preferences may be created on the user device and stored on the interdevice communication server. In an alternative embodiment, the preferences may be stored in the user device and transmitted to the server when a connection attempt is made.

If the initiating user does not have the preference, a determination is made as to whether the receiving user has a preference at step 515. Users may likewise specify the device and manner in which they prefer to be contacted. Users may specify, for example, that they will prefer to be contacted via their instant messaging client on their cellular phone first, and next via their instant messaging client on their computer. It will be recognized that steps 510 and 515 may be reversed or combined. If the steps are combined, for example, and both users have preferences which conflict, a notification mechanism may be used to indicate to the initiating user that a conflict exists and prompting the user for a selection of the alternatives. Still further in the combined preference case, one of the initiating or receiving user's preferences may be set to take precedence.

Returning to FIG. 5, at step 520, if the connection preference is available, the initiating user is connected to the receiving user at the preferred device and via the preferred mode of communication at step 525.

If the user is not known at step 505, or if the preferred connection device is not available at 520, then the method checks at step 530 to determine whether presence information for the user is available. If presence information is available, the user will be connected to the point of presence at step 535. Generally, the presence information will include information on the type of communication (e.g. instant messenger) available at the presence point. If no presence information is available at step 530, then a test at step 540 is made to determine whether or not one of the contact points can support a basic communication type to forward a message. For example, if the user regularly uses a cellular phone which receives SMS messages, then a message can be initiated using SMS. The message initiated at step 210 can be forwarded to the user via an SMS message with reasonable certainty that the SMS message will be received by the user. If a communication type is known, then a connection will be made at step 545 via the known communication type. The base medium may be one in which the context of the message is preserved in a format which allows the reader to see it at a later date. This may include, for example, email, SMS, or other medium which is stored until the second user has a chance to view the message. If no known communication type is available, then at step 550, the initiating user will be notified.

FIG. 6 illustrates the manner in which connected users not having the same interface can communicate. FIG. 6 illustrates a method performed at step 225 when a communication is forwarded to a second user. In accordance with this step, the system determines whether the communication type of the receiver can receive the communication type of the sender. The message received at step 605 is provided when the user initiates non-voice communication. At step 610, the method first determines whether or not the communication type utilized to send the data is available to the second user. In this example, User 1 and User 6, having the same communication devices, may communicate using the same protocol and same messaging interface. Similarly, the unified messaging interface can provide real time messages within an instant messaging client. However, if real-time messaging is utilized with a user who does not have an instant messaging client or real time texting client, the message needs to be translated to a format that the second user's machine can understand. If the communication type is available, then the data is passed to the recipient using an equivalent communication type at 615. If the communication type is not available, then at step 620, a determination is made as whether or not a user preference is available for the communications type. This can be a receiving user preference or an initiating user preference. If the receiving user has a communication preference, for example the receiving user has determined that he would like to receive messages via SMS, then the message is handled according to the user's preference at step 625. If no user preference is set at step 620, then a automatic determination is made at step 630 to determine whether or not an acceptable alternative is available on the receiving device. At step 630, the automatic determination examines available communication types on the receiving device to determine both possible alternatives and preferred alternatives. For example, this can include determining whether or not the message can be converted to an alternative text format such as email which can be received on a receiving device. If there is more than one possible alternative, (for example the receiving user is capable of receiving both email and SMS,) then since the user has not indicated a preference, the technology automatically makes a determination of which alternative communication type to use. The choice of a preferred alternative format can be made based on a number of considerations, including speed, computational cost (to both the inter-device server in making the translation and the receiving user device in interpreting the received message format), financial cost and other factors. In one embodiment, the capabilities of the receiving user's device which lacks a data channel may, for example, compel sending a link data on a web page rather than a file attachment. Similarly, where a user's data plan with a cellular provider allows for unlimited SMS messages, but limited Internet browsing bandwidth, a preference for SMS may be automatically set higher.

If the next acceptable format is available, then at step 635, the data is translated and forwarded via the alternative communications medium. This can include taking the message illustrated in FIG. 3, converting it to an email, and forwarding it to the email address of the recipient at step 635. If no alternative is available on the receiving device, a determination will be made at step 640 as to whether or not an alternative is accessible by the receiving device.

Suppose, for example, that the sending user attempts to send an image to the receiving device. Suppose further, that the receiving device is only capable of receiving SMS messages, but not displaying images. The determination at step 640 may determine that the receiving device is capable of browsing the Internet. Thus, the receiving device is capable of accessing the image by other means. In this example, the translator 134 can upload or host the image on an accessible Internet server and send a URL link at step 645 to the location where image is hosted. If no alternative is accessible by the receiving device, then at step 650, an alternative contact point inquiry is made. If an alternative contact point is available, then the data may be sent to an alternative contact point for the user at 655. For example, if the user is connected via an SMS messaging device, but also has an email address, the image may be forwarded to the user's email. Finally, if no alternatives are available, then at step 660, an indication is sent that the information type is not allowed.

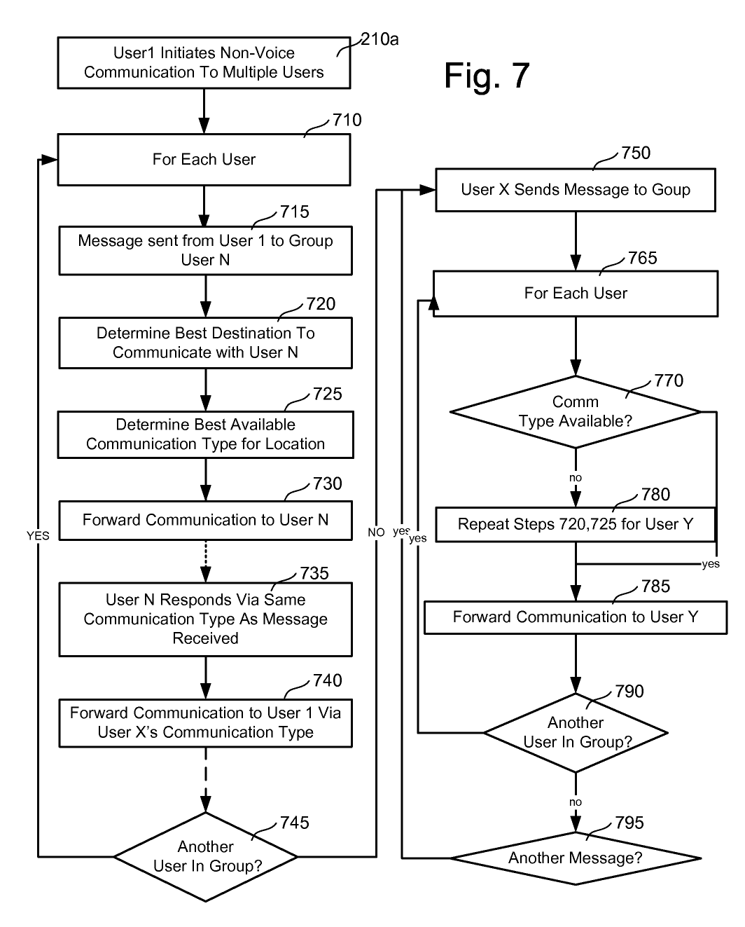

FIG. 7 illustrates a method in accordance with the present technology for handling messages between a number of users. FIG. 7 is similar to FIG. 2 and the method 290, except that a plurality of users may be communicating in a group environment. At step 210a, a user initiates a non-voice communication to multiple users. Step 210a is similar to step 210 and implemented via a similar interface (discussed below) except that instead of the initialing user addressing a single user, a group contact list or multiple users are listed in the address line. At step 710, for each of a plurality of users, a message is sent from User 1 to the group user. A group may include N users, where N is an integer, and the FOR-loop represented by steps 710-740 is repeated for each user in the group. The message is sent from User 1 to User N at step 715, and at step 720, a determination is made as to the best destination to communicate with User N. Step 720 is equivalent to step 215 in FIG. 2 and may be performed in accordance with the method of FIG. 5. At step 725, the best available communication type for the location is determined, and the communication is forwarded to User N in the communication type at step 730. At step 735 when User N responds via the same communication type as the method received, the communication from User N to User 1 is forwarded via User l's communication type at 740. Again, for User 1, the message is received in a unified interface, as shown in FIGS. 8 and 9. After messages are distributed to all users, and the loop at 745 is completed, return communications are handled in a similar manner. In steps 750-765, User X represents a sending user while User Y represents any user 1-N in the user group. At step 750, when User X forwards a message to the group, then for each user at step 765, a determination is made at step 770 as to whether or not the communication type remains available for that user. At step 770, if no communication type is still available for the particular user, then steps 720 and 725 are repeated for that user. If the communications type is available, then the message is forwarded at 785. Once the communication type is established for each at 790, the communication is forwarded to User Y until the communication session ends at step 795.

FIGS. 8 and 9 illustrate the user interface for the unified communication application wherein a group communication is utilized. Numerous methods are available for communicating with a group. In one embodiment, a text communication may be addressed to a group and in accordance with the technology discussed herein, the communication will be forwarded to each user in the group at their contact point and using the best communication type. Another example is illustrated in FIG. 8 wherein an invitation to a group event is illustrated. In FIG. 8, an event location panel 810 may be provided when an invite selection is selected on the menu 815. An address panel 820 includes the address of the group to whom the invitation is to be sent, the location, and the time of the invitation. A message 830 is drafted in the message panel 825 by the text implementing means of the device which the user is operating on. Selecting a send menu option on menu 835 allows the message to be sent to all the users in the group in accordance with the method of step 215 in FIG. 7. Once the message is sent, a message screen such as that shown in FIG. 9 can be provided. The message screen includes a threaded message display 845 which shows a sequence of messages presented to User 1 from the other users. The mechanism by which each user responds is transparent to User 1. To User 1, the conversation is a threaded conversation much like an instant message conversation. However, User 2 may in fact be replying via an email client or an IM client, while User 3 may be replying via a web browser.

FIG. 10 depicts an example of typical architecture for a mobile communication device. The device 1000 has memory 1010, a physical connector 1020, processor 1040, an input/output (I/O) controller 1050, a cellular radio channel and WLAN/WMAN data channel 1060, and power controller 1070. Each of these components is connected through the system bus 1080 of the cell phone 1000.

Memory 1010 includes the device's operating system 1012, applications 1014, and non-volatile storage 1030. Memory 1010 can be any variety of memory storage media types, including non-volatile and volatile memory. The operating system 1012 handles the different operations of the device 1000 and may contain user interfaces for operations, such as placing and receiving phone calls, text messaging, checking voicemail, and the like. The applications 1014 can be any assortment of programs, such as a camera application for photos and/or videos, an address book application, a calendar application, a media player, an internet browser, games, an alarm application, other third party applications, and the like. The non-volatile storage component 1030 in memory 1010 contains data such as web caches, music, photos, contact data, scheduling data, and other files.

The operating system 1012 manages the hardware of the device 1000, including hardware such as the display 1052, speaker 1054, an input panel 1056, and camera 1058. The input panel may comprise a keyboard, or touch-screen or input may be provided via voice commands as known in the art. The operating system 1012 also manages software (i.e. applications 1014) on the device 1000 for performing tasks requested by the user and handling incoming data, for example. This occurs through the operating system's control and allocation memory (i.e. RAM), system tasks, system resources, files systems, and the like. The processor 1040 executes operations for the device according to this control and allocation. For example, a user may attempt to open a video file through a media player application using the input panel 1056 on the device 1000. In this case, the operating system 1012 may direct the processor 1040 to open the desired file stored in the non-volatile storage component 1030. During this process, the operating system 1012 may also direct the processor 1040 to control the operation of other applications concurrently in use, such as an application for receiving calls. Once the file is accessed, the operating system 1012 may direct the processor 1040 to control the input and output devices using the I/O controller 1050 to play the sounds on speaker 1054 and images on display 1052 for the video file.

The power controller 1070 of the device 1000 allocates power from the device's power supply 1072 to the circuitry for different device components used to operate the cell phone 1000 and its different features.

Additionally, the physical connector 1020 can be used to connect the device 1000 to an external power source, such as an AC adapter or powered docking station. Such a connection can be used to charge the device's power supply 1072 via the power controller 1070. The physical connector 1020 can also be used as a data connection to a computing device. The data connection allows for operations such as synchronizing device data with the computing data on another device.

The device 1000 also contains a cellular radio channel and WLAN/WMAN data channel 1060 for receiving and transmitting data, such as phone calls, text messages, email, webpage data, and the like. Cellular radio communication can occur through any of the standard network protocols of device communication (i.e. GSM, PCS, D-AMPS, UMTS, and the like.). The device 1000 may also contain additional communication channels 1062, such as Wi-fi, Bluetooth, and the like, for receiving and transmitting data as well. The device 1000 may have additional functional elements for communication 1064, such as GPS. Each of the described communication mediums is accessed via the antenna 1066 on the device 1000. The communication mediums for operations of the device 1000 are not limited to the mediums described and can include any other communication mediums known in the art.

FIG. 11 illustrates an example of a suitable computing system environment 1100 on which the technology may be implemented. Environment 1 100 may comprise server 100 or any of the user devices 120-190 in FIG. 1.

The computing system environment 1100 is only one example of a suitable computing environment and is not intended to suggest any limitation as to the scope of use or functionality of the technology. Neither should the computing environment 1100 be interpreted as having any dependency or requirement relating to any one or combination of components illustrated in the exemplary operating environment 1100.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The technology has been described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the technology includes a general purpose computing device in the form of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1140 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through an non-removable memory interface such as interface 1140, and magnetic disk drive 1151 and optical disk drive 1155 are typically connected to the system bus 1121 by a removable memory interface, such as interface 1150.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. A user may enter commands and information into the computer 20 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through a output peripheral interface 1190.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in the remote memory storage device. By way of example, and not limitation, FIG. 1 illustrates remote application programs 185 as residing on memory device 1181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for operating a mobile communications system, comprising:
receiving a text communication from a first user destined for a second user;
selecting one of a number of user communication points on which to connect the text communication to the second user;
determining a suitable communication format capable of displaying the text on the selected communication point; and
forwarding the text communication to the second user using the communication format.

2. A method according to claim 1 wherein the text communication from the first user is received in a first communication format, and the method further includes providing the text communication to the second user in a second communications format.

3. The method of claim 1 wherein the method further includes the step of
receiving a reply message from the second user in the second communications format; and
forwarding the reply message to the first user in the first communications format.

4. The method of claim 1 further including the step of providing a unified messaging interface on a first user device, and the step of receiving includes receiving the text communication from the unified messaging interface.

5. The method of claim 1 wherein the step of receiving is performed via a data network and the step of forwarding is performed via a cellular network.

6. The method of claim 1 wherein the second communications format comprises one of an instant messaging format; an email; or a SMS message.

7. The method of claim 1 wherein the step of selecting includes:
determining whether the first user has a communication point preference with the second user;
determining whether the communication point is available; and
if the communication point is available, connecting to communication point and if the communication point is not available, connecting to an alternative communication point.

8. The method of claim 1 wherein the step of selecting includes:
determining whether the second user has a communication point preference;
determining whether the communication point is available; and
if the communication point is available, connecting to communication point and if the communication point is not available, connecting to an alternative communication point.

9. The method of claim 1 wherein the step of selecting includes one or more of:
determining whether presence information on for the second user is available.

10. A method for operating a communications system connecting users having a plurality of different connection points and connection devices, comprising:
receiving a text communication from a sending user destined for a group of receiving users;
selecting one of a number of contact points for each receiving user;
determining a suitable communication format capable of displaying the text at each contact point;
providing the text communication to each of the group of receiving users using the communication format determined for each point.

11. A method according to claim 10 wherein the text communication from the first user is received in a first communication format, and the text communication at least one of the group is provided in a second communications format.

12. The method of claim 11 wherein the method further includes the step of
receiving a reply message from a second user in the second communications format and
forwarding the reply message to the first user in the first communications format.

13. The method of claim 12 wherein the second communications format comprises one of an instant messaging format; an email; or a SMS message.

14. The method of claim 12 wherein the step of selecting includes one or more of:
determining whether the first user has communication preferences with each group user;
determining whether each group user has communication preferences indicating how the group user wishes to be contacted; and/or determining whether presence information for each group user is available.

15. The method of claim 10 further including the step of determining whether the communication format of the first user is compatible with that of each group user and if not, translating the text communication to an alternate text format suitable for each group user.

16. A method for operating a communications system connecting users having a plurality of different connection points and connection devices, comprising:
receiving a text communication in a first communication format from a sending user destined for a receiving user;
selecting one of a number of contact points for the receiving user;
determining a suitable second communication type capable of displaying the text at the contact point;
converting the text from the first communication format to the second communication format; and
providing the text communication to the user using the second communication format.

17. The method of claim 16 wherein the method further includes the step of receiving a reply message from the second user in the second communications format; and
forwarding the reply message to the first user in the first communications format.

18. The method of claim 17 wherein the step of selecting includes determining whether the first user has a communication point preference with the second user;
determining whether the communication point is available; and
if the communication point is available, connecting to communication point and if the communication point is not available, connecting to an alternative communication point.

19. The method of claim 18 wherein the step of selecting includes determining whether the second user has a communication point preference;
determining whether the communication point is available; and
if the communication point is available, connecting to communication point and if the communication point is not available, connecting to an alternative communication point.

20. The method of claim 16 further including repeating said steps of receiving, selecting, determining, converting and providing for a plurality of users.
